(19) United States
(12) Patent Application Publication
(10) Pub. No.: US 2014/0149306 A1
(43) Pub. Date: May 29, 2014

(54) Method and System for Providing a Remote Shipping Cost Estimate Based on Image Data of Goods to be Shipped

(71) Applicant: Mark Olsen, Longmont, CO (US)

(72) Inventor: Mark Olsen, Longmont, CO (US)

(21) Appl. No.: 13/684,532

(22) Filed: Nov. 24, 2012

(51) Int. Cl. G06Q 10/08

(52) U.S. Cl. CPC G06Q 10/08345
USPC 705/330

(57) ABSTRACT

An improved method for providing a remote shipping cost estimate of goods is disclosed, the method including remotely receiving image data of a transferee's goods, obtaining a shipping cost estimate of the transferee's goods that is based on the remotely received image data, and making the shipping cost estimate available to the transferee. In preferred embodiments, image data is digital data that can be uploaded by a transferee through a user interface and received by an estimator over a computer network such as the Internet. In some preferred embodiments, the method can be computer-based, and in some embodiments it can be implemented by a software system stored on computer-readable media. This improved method adds a new level of convenience for both estimators and transferees, while also improving the efficiency of providing shipping cost estimates in general.

### TECHNICAL FIELD

The invention relates generally to relocation and moving services, and more particularly to providing shipping cost estimates for remotely located goods.

### BACKGROUND

Moving to a new location is a great undertaking, and various types of relocation suppliers offer their services to help. One type of supplier is the moving company, which physically moves household goods (or even workplace goods) for relocation. One of the important decisions faced by a relocating person (hereinafter referred to as a “transferee”) is choosing the right moving company to help them with their move.

Shipping cost estimates can significantly influence a transferee's selection of a moving company. Such cost estimates generally depend upon the weight and/or volume of the goods, and the distance they must be moved. In assessing a total weight for the goods, typically the volume that the goods would occupy in the moving van or trailer is first estimated by viewing the goods; then, that volume is multiplied by a conversion factor to estimate their weight.

Traditionally, estimating the shipping cost of household (or workplace) goods is facilitated by either an on-site physical survey of the goods, or by remote survey that is executed via telephone or via written questionnaire. However, physical surveys are cumbersome both for transferees, who must host a survey for each estimate that they seek, and for estimators, who must travel to the site of goods.

Remote surveys can be less time-consuming for estimators because they are not required to travel to the site of the goods. However, current processes for performing remote surveys demand that transferees spend considerable time and energy distilling relevant information for estimators. Even with this extra effort, such remote surveys do not afford shipping cost estimators the same level of information that is commonly available to them through the on-site viewing that is afforded by a physical survey.

### SUMMARY

An improved method for providing a shipping cost estimate of goods is claimed, including remotely receiving image data of a transferee's goods, obtaining a shipping cost estimate that is based on the remotely received image data, and making the shipping cost estimate available to the transferee. This improved method for remotely estimating shipping costs adds a new level of convenience and efficiency, for both transferees and shipping cost estimators.

The present method affords estimators substantially the same level of information as is available in a physical survey, without requiring the estimator to actually travel to the site of goods to be shipped. It also enables transferees to easily provide estimators with the requisite information, without having to either host physical surveys, or struggle to personally convey the most relevant and pertinent details themselves via phone or written questionnaire.

Since visually inspecting goods is more informative than talking or reading about those goods, the present method enables estimators to provide estimates that are more accurate than estimates from other types of remote survey. When implemented with the proper instructions, this new type of remote survey can be just as accurate as a physical survey—while also being more convenient than all other known surveys, both remote and physical.

In accordance with the present method, video image data can be particularly helpful in many situations. For example, a transferee can use video image data capture to better convey a three-dimensional representation of their household or workplace goods. Video image data can also provide the estimator with better depth perception of the goods, than photograph image or other data capture. In preferred embodiments, the transfer of image data from transferee to estimator, and the transfer of shipping cost estimate from estimator to transferee, can be further streamlined by a computer-based, software-enabled system.

A method for providing a shipping cost estimate of goods requiring shipment is claimed, the method in one general aspect including remotely receiving image data of a transferee's goods, obtaining a shipping cost estimate of the transferee's goods that is based on the remotely received image data, and making the shipping cost estimate available to the transferee.

In some embodiments, the image data includes at least one video. In some of those embodiments, at least one video is a digital video. In some embodiments, the image data is received over a telecommunications network. In some embodiments, the image data is received over the Internet. In some embodiments, the image data of the transferee's goods is associated with a specific user account.

In some embodiments, a camera is used to capture the image data. In some embodiments, a mobile device is used to capture the image data. In some embodiments, a mobile device is used to send the image data. In some embodiments, the image data is uploaded via a graphical user interface. In some embodiments, the image data is uploaded via a web page.

In some embodiments in which the image data is uploaded via a web page, the web page is operated by a party that also provides the remote shipping cost estimate. In other such embodiments, the web page is operated by a party that does not provide the remote shipping cost estimate.

In some embodiments, the remote shipping cost is estimated by a moving company. In some other embodiments, the remote shipping cost is estimated by a move management company. In some other embodiments, the remote shipping cost is estimated by a relocation consulting company. In still other embodiments, the remote shipping cost is estimated by a surveyor.

A computer-based method for providing a remote shipping cost estimate of a transferee's goods is also claimed, the method in one general aspect including remotely receiving image data of a transferee's goods over a computer network, the image data being associated with a specific user account, obtaining a shipping cost estimate of the transferee's goods that is based on the remotely received image data, the shipping cost estimate also being associated with the specific user account, and making the shipping cost estimate available to the transferee over the computer network, via the specific user account.

In some embodiments of the computer-based method, the image data is received through a user interface provided to the transferee over the network.

A computer software system for providing a remote shipping cost estimate of a transferee's goods is also claimed, the method in one general aspect having a set of instructions for controlling at least one computer device and being stored on computer-readable media, which when executed by the at least one computer device carries out a method including remotely receiving image data of a transferee's goods, obtaining a shipping cost estimate of the transferee's goods that is based on the remotely received image data, and making the shipping cost estimate available to the transferee.

### BRIEF DESCRIPTION OF THE DRAWINGS

The invention will be more fully understood by reference to the detailed description, in conjunction with the following figures, wherein:

FIG. 1 is an elements diagram of an image data capture and transfer system in accordance with an embodiment of the invention, wherein image data is captured by a camera and transferred over the Internet via a web page, to be retained on a remote database for surveying purposes;

FIG. 2 is a perspective view of a transferee using a camera to capture image data of goods to be shipped, to obtain a cost estimate;

FIG. 3 is a perspective view of a transferee using a mobile device to capture image data of goods to be shipped, to obtain a cost estimate;

FIG. 4 is a perspective view of a transferee having uploaded image data of goods, to obtain a shipping cost estimate from an estimator;

FIG. 5 is a perspective view of an estimator surveying the image data indicated in FIG. 4, on a computer, to provide a shipping cost estimate;

FIG. 6 is a function diagram depicting a central server that is collecting image data from multiple transferees, obtaining shipping cost estimates from an estimator based on the image data, and making each estimate available to the respective transferees, in accordance with an embodiment of the invention; and

FIG. 7 is a flowchart detailing the steps of an embodiment of the invention, wherein image data is recaptured and/or resent as necessary.

### DETAILED DESCRIPTION

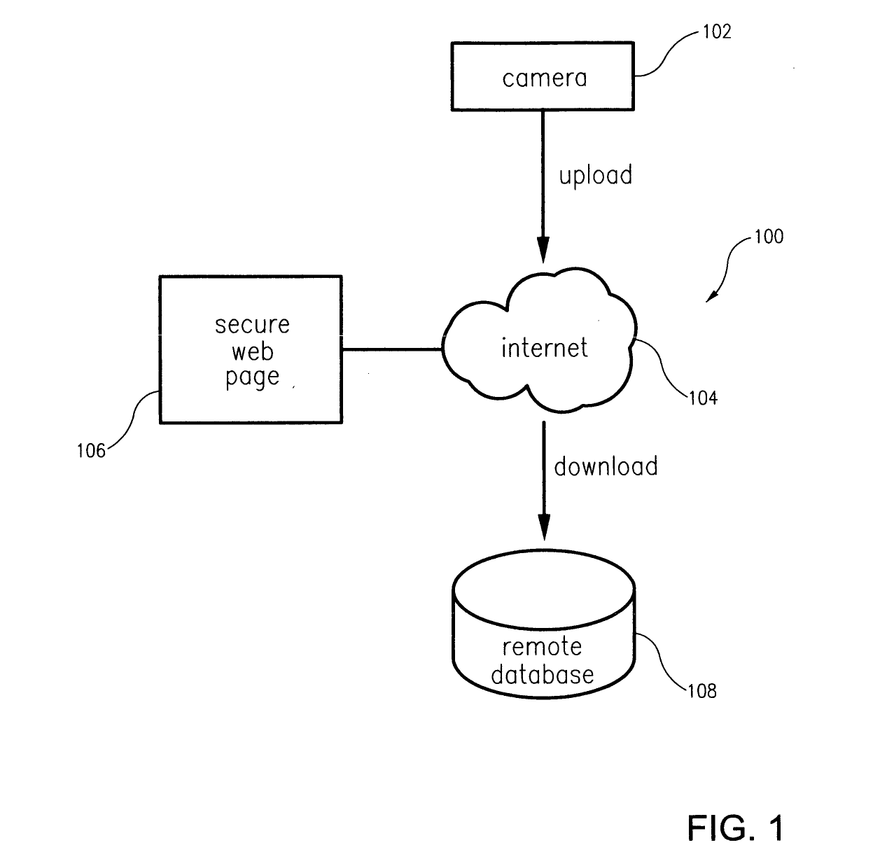

FIG. 1 is an elements diagram of an image data capture and transfer system in accordance with an embodiment of the invention, wherein image data is captured by a camera and transferred over the Internet via a web page, to be retained on a remote database for surveying purposes. While the embodiment shown in FIG. 1 depicts a remote database, the method can also be implemented by storing image data on a distributed database, storage area network, file server, server with streaming media software, or by any other storage mechanism apparent to one of ordinary skill in the art.

In various embodiments, image data 102 can be uploaded and sent via a computer, mobile device, or other means readily apparent to one of ordinary skill in the art of data transfer. Furthermore, in various embodiments the image data 102 can be transferred over a telecommunications network such as a computer network (e.g. the Internet) or cellular network, or other type of network altogether.

In the image data capture and transfer system 100 shown in FIG. 1, image data of goods to be shipped (such as household goods or workplace goods, for example) is captured by a camera 102. Such image data can include digital and/or analog video, digital and/or film photograph, and/or any other type of relevant image data apparent to one of ordinary skill in the art.

In alternative embodiments, image data can be captured by another image data capturing device other than a camera 102, such as a mobile device, or any other image data capturing device apparent to one of ordinary skill in the art.

In the embodiment of FIG. 1, the image data is uploaded from the camera 102 onto the Internet 104 to be transferred over the Internet 104, once it has been captured by the camera 102. In alternative embodiments, the image data 102 can be transferred over another type of computer network other than the Internet 104, or by another type of telecommunications network besides a computer network, such as a cellular network. Alternatively, the image data 102 can be transferred by different non-network-based transfer modes such as mail, fax, courier, or any other applicable means of data transfer, apparent to one of ordinary skill in the art, which could support image data transfer.

In preferred embodiments, the image data is transferred over the Internet 104 via a secure web page 106, to be retained on a remote database 108 for surveying purposes, as shown. In some preferred embodiments, the secure web page 106 can be password-protected. In some embodiments, a web page located within a secured (e.g., encrypted) web application requiring password authentication and/or other means to identify the user (such as a CAPTCHA test, for example) can be used. In other embodiments, an unsecured web application, which may or may not require password authentication, can be used.

In other embodiments, the secure web page 106 can be a non-password-protected web page. In alternative embodiments, the image data can be transferred over a non-secure web page. In some embodiments, the web page 106 can be part of a web site, including multiple web pages stored on a common directory. In the embodiment shown, the image data 102 is stored on a remote database 108 once it has been transferred over the Internet. In alternative embodiments, the image data 102 can be surveyed without being stored on a remote database 108. In other embodiments, the image data 102 can be transferred via other electronic means over the Internet besides a web page, such as a local or wide area network, web application or web service (e.g. HTTP, XML or the like), for example. Any other means of image data transfer over the Internet that is readily apparent to one of ordinary skill in the art can also be used.

In some embodiments using a web page 106, the web page 106 through which the image data is transferred can be maintained and/or operated by the same party that provides the remote shipping cost estimate of the goods to be shipped. For example, such a web page 106 can be maintained and/or operated by a moving company or move management company which has its own shipping cost estimators to provide the shipping cost estimate.

Alternatively, in other embodiments the shipping cost estimate can ultimately be provided by a party other than the party that maintains and/or operates the web page 106. For example, the web page 106 can be maintained and/or operated by a moving company or move management company that outsources the shipping cost estimate to a separate group of estimators, such as professional surveyors for example. In still other embodiments, shipping cost estimates can be obtained and/or provided by a relocation consulting company. Any such companies may have surveyors on staff.

A service provider implementing the method disclosed herein can obtain a shipping cost estimate by providing it themselves, or alternatively, such a service provider can obtain a shipping cost estimate by outsourcing the task to another provider of shipping cost estimates.

In some embodiments, the image data can be transferred over the Internet 104 via other means such as email (including via a mobile device), instant messenger, file transfer protocol (FTP), secured file transfer protocol (SFTP), client-server network, peer-to-peer network, cloud computing, web service, and/or any other means available for transferring image data over the Internet 104 that is apparent to one of ordinary skill in the art.

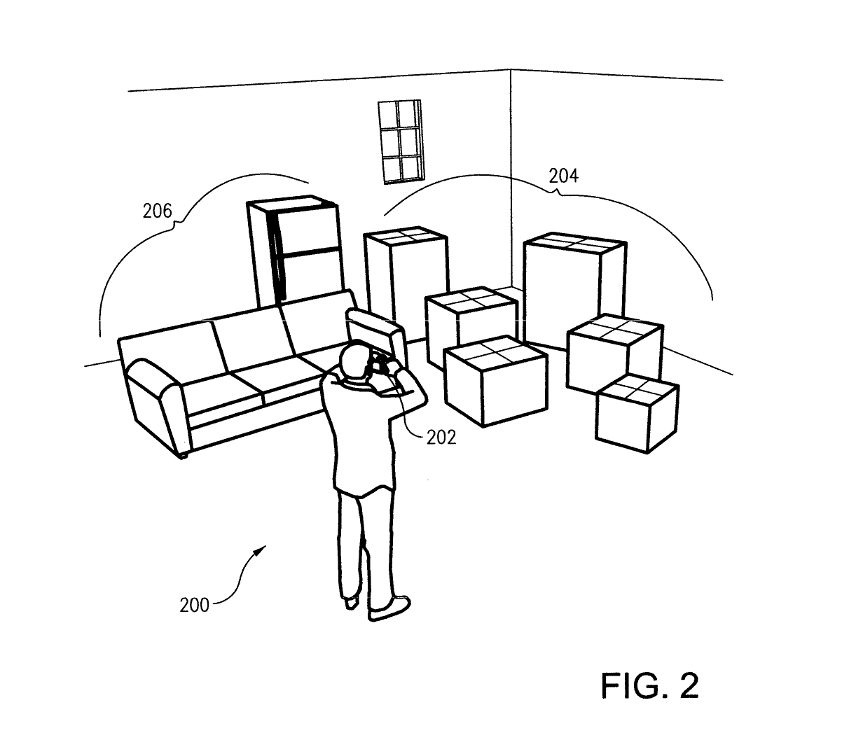

FIG. 2 is a perspective view of a transferee using a camera to capture image data of goods to be shipped, to obtain a cost estimate.

In the embodiment shown, a transferee 200 uses a camera 202 to capture image data of the transferee's household goods 204. While some goods are in boxes as shown, other goods may be unboxed, such as furniture 206. In such situations, a shipping cost estimate can also include information regarding the need for boxes to pack items not yet packed by the transferee 200, such as the furniture 206 shown. If there are multiple rooms containing household goods 204, the transferee 200 can use the camera 202 to capture image data of the household goods 204 in each room.

In some preferred embodiments, the camera 202 can be a digital camera, and in some of these embodiments the digital camera can be a digital video camera. Capturing video data of the household goods 204 can provide estimators with a more accurate sense of the depth and volume of the household goods 204, and therefore can be especially useful for estimators in providing accurate shipping cost estimates.

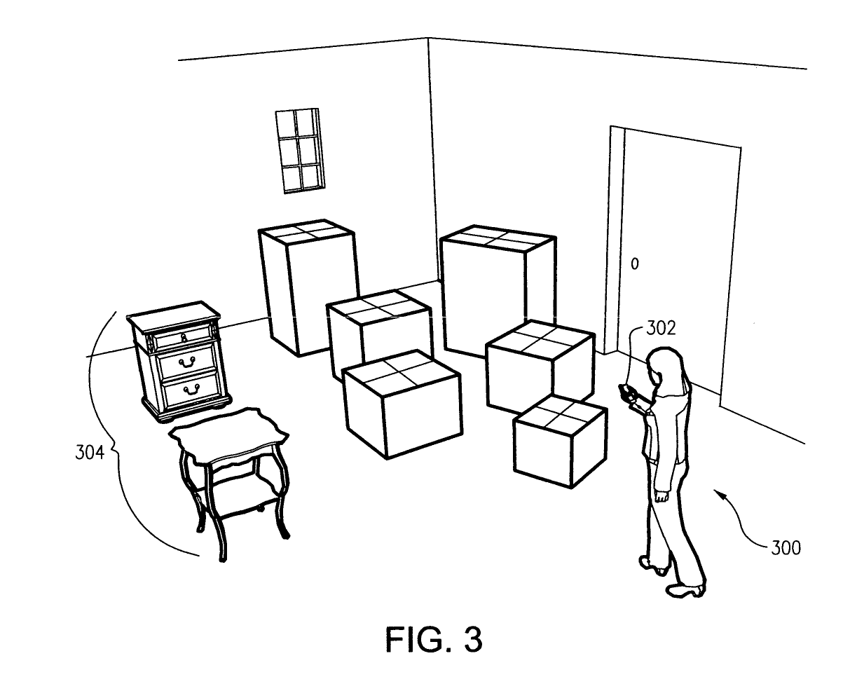

FIG. 3 is a perspective view of a transferee using a mobile device to capture image data of goods to be shipped, to obtain a cost estimate.

In the embodiment shown, a transferee 300 uses a mobile device 302 to capture image data of the transferee's workplace goods 304. If there are multiple rooms containing workplace goods 304, the transferee 300 can use the mobile device 302 to capture image data of the workplace goods 304 in each room. Again, some goods may be in boxes already, while other goods such as furniture for example may not yet be in boxes. Image data can help a service provider determine whether a box may be required, and what type of box (size, sturdiness, dimensions etc.).

In some preferred embodiments, the mobile device 302 can act as a camera phone, and in some of these embodiments the camera phone can capture video. Capturing video data of the workplace goods 304 can provide estimators with a more accurate sense of the depth and volume of the workplace goods 304, and therefore can be especially useful for estimators in providing accurate shipping cost estimates.

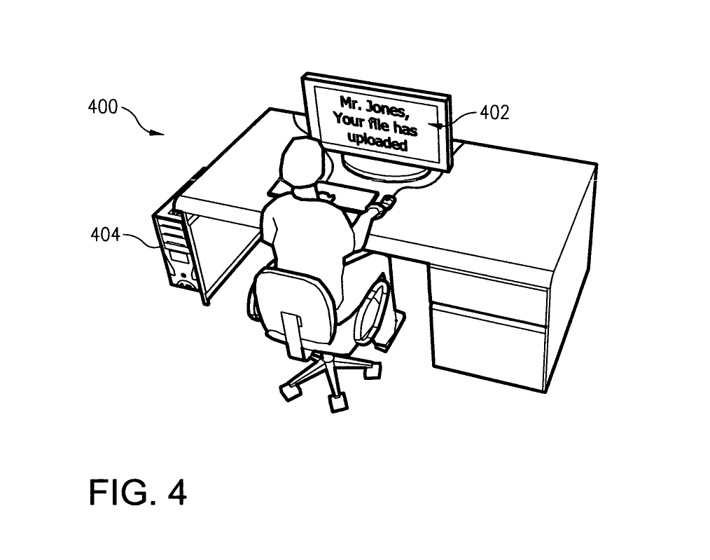

FIG. 4 is a perspective view of a transferee having uploaded image data of goods, to obtain a shipping cost estimate from an estimator. In the embodiment shown, a transferee 400 has used a graphical user interface 402 to upload and transfer the image data over the Internet, using a computer 404. In other embodiments, a transferee 400 can upload and/or send image data via other means, such as a mobile phone, for example.

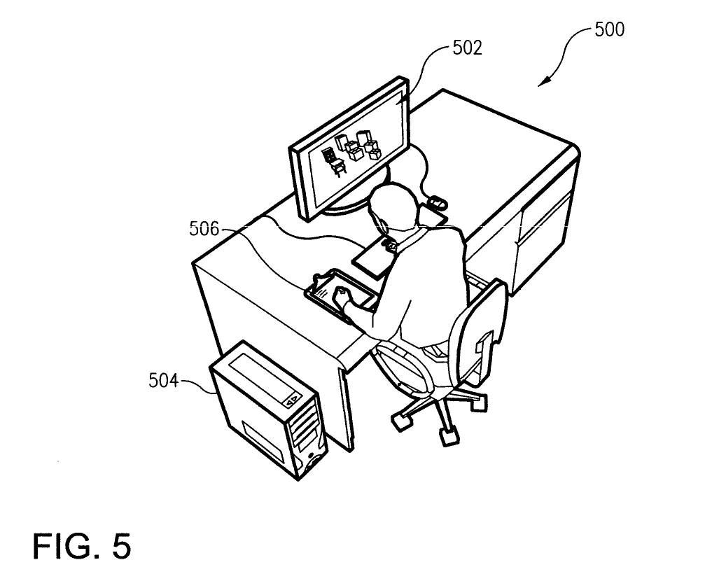

FIG. 5 is a perspective view of an estimator 500 surveying the image data 502 indicated in FIG. 4 on a computer 504, to provide a shipping cost estimate. In some other embodiments, an estimator 500 can receive image data for review by some other means than computer 504. The shipping cost estimate can be recorded on paper 506 (as shown) and/or computer, via a graphical user interface, for example.

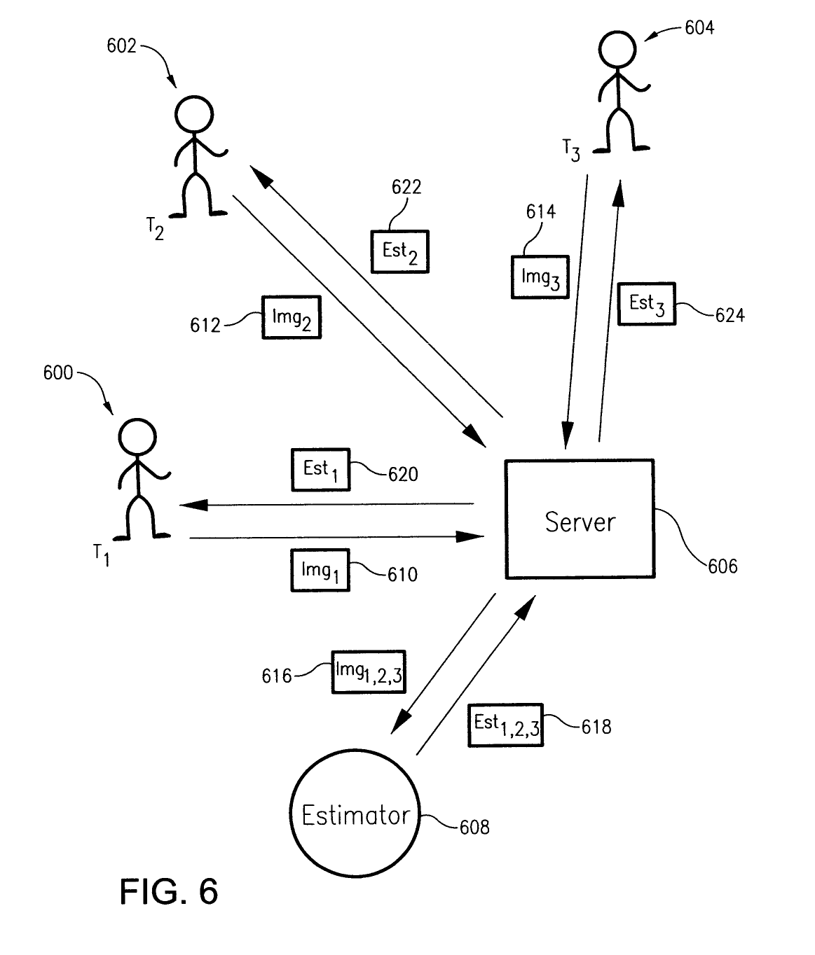

FIG. 6 is a function diagram depicting a central server that is collecting image data from multiple transferees, obtaining shipping cost estimates from an estimator based on the image data, and making each estimate available to the respective transferees, in accordance with an embodiment of the invention. In the embodiment shown, three separate transferees T₁ 600, T₂ 602 and T₃ 604 send data which is shared via a common server 606, which directs all the image data to an estimator 608. Each of the transferees sends image data of their household or workplace goods: Img₁ 610, Img₂ 612 and Img₃ 614, for T₁ 600, T₂ 602 and T₃ 604, respectively. According to the embodiment shown, the image data of a given transferee is associated with a specific user account, so as to keep the correct image data Img₁ 610, Img₂ 612 and Img₃ 614 associated with the correct transferees T₁ 600, T₂ 602 and T₃ 604.

The server 606 routes all the image data 616 to an estimator 608, to obtain shipping cost estimates 618 based on the image data 616. The estimator 608 can be the party that received the image data or an employee thereof; or it can be a separate independent party or an employee thereof, for example. The shipping cost estimates 618 are then routed by the server 606 to be made available to the transferees. Due to each transferee's image data being associated with a unique user account, the shipping cost estimates Est₁ 620, Est₂ 622, Est₃ 624 are each directed to the appropriate account: T₁ 600, T₂ 602 and T₃ 604, respectively.

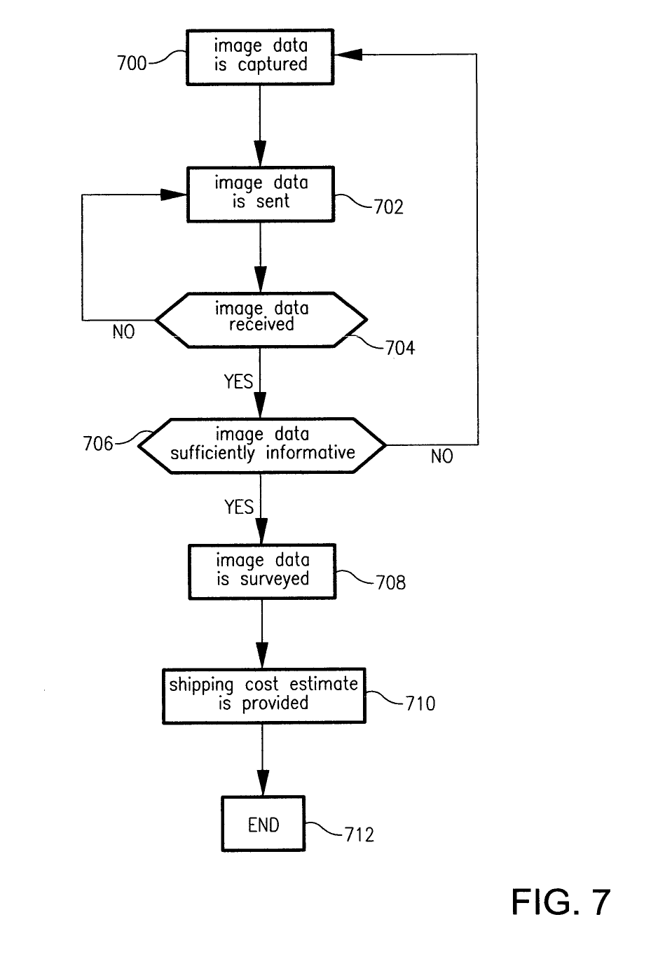

FIG. 7 is a flowchart detailing the steps of an embodiment of the invention, wherein image data is recaptured and/or resent as necessary. First, image data is captured 700 and sent 702. The image data can be captured by a camera such as a point-and-shoot camera, digital camera, film camera, video camera and/or camcorder for example, or by mobile device such as a camera phone, for example.

If the image data is not received by the service provider 704 it can be resent. On the other hand, if the image data is received but is deemed insufficiently informative 706, the image data can be recaptured. This may be the case if, for example, some of the transferee's goods are obscured or otherwise not sufficiently depicted in the image data, thereby rendering it difficult or impossible to estimate their volume.

An estimator then surveys the image data 708, so that a shipping cost estimate can be obtained. The estimator can be the party that received the image data or an employee thereof; or it can be a separate independent party, or an employee thereof, for example. Once the image data is surveyed 708 and the shipping cost estimate has been obtained, the shipping cost estimate is then made available to the transferee 710, after which time the method as depicted in FIG. 7 is concluded 712.

A computer-based method for providing a remote shipping cost estimate of a transferee's goods is also disclosed herein. Such a computer-based method can include remotely receiving image data of a transferee's goods over a computer network, the image data being associated with a specific user account, obtaining a shipping cost estimate of the transferee's goods that is based on the remotely received image data, the shipping cost estimate also being associated with the specific user account, and making the shipping cost estimate available to the transferee over the computer network, via the specific user account.

In some embodiments of the computer-based method, the image data can be received through a user interface provided to the transferee over the network.

A computer software system for performing the method is also disclosed herein, the system having a set of instructions for controlling at least one computer device and being stored on computer-readable media. When executed by the one or more computing devices, the software system can carry out the method as disclosed above. As an example, the software system can send a transferee's image data to an estimator and solicit a shipping cost estimate, or in some embodiments may even be able to produce an estimate on its own.

Other modifications and implementations will occur to those skilled in the art without departing from the spirit and the scope of the invention as claimed. Accordingly, the above description is not intended to limit the invention except as indicated in the following claims.

What is claimed is:

1. A method for providing a remote shipping cost estimate of a transferee's goods, the method comprising:
remotely receiving image data of a transferee's goods;
obtaining a shipping cost estimate of the transferee's goods that is based on the remotely received image data; and
making the shipping cost estimate available to the transferee.

2. The method of claim 1, wherein the image data includes at least one video.

3. The method of claim 2, wherein at least one video is a digital video.

4. The method of claim 1, wherein the image data is received over a telecommunications network.

5. The method of claim 1, wherein the image data is received over the Internet.

6. The method of claim 1, wherein the image data of the transferee's goods is associated with a specific user account.

7. The method of claim 1, wherein a camera is used to capture the image data.

8. The method of claim 1, wherein a mobile device is used to capture the image data.

9. The method of claim 1, wherein a mobile device is used to send the image data.

10. The method of claim 1, wherein the image data is uploaded via a graphical user interface.

11. The method of claim 1, wherein the image data is uploaded via a web page.

12. The method of claim 11, wherein the web page is operated by a party that also provides the remote shipping cost estimate.

13. The method of claim 11, wherein the web page is operated by a party that does not provide the remote shipping cost estimate.

14. The method of claim 1, wherein the remote shipping cost is estimated by a moving company.

15. The method of claim 1, wherein the remote shipping cost is estimated by a move management company.

16. The method of claim 1, wherein the remote shipping cost is estimated by a relocation consulting company.

17. The method of claim 1, wherein the remote shipping cost is estimated by a surveyor.

18. A computer-based method for providing a remote shipping cost estimate of a transferee's goods, the method comprising:
remotely receiving image data of a transferee's goods over a computer network, the image data being associated with a specific user account;
obtaining a shipping cost estimate of the transferee's goods that is based on the remotely received image data, the shipping cost estimate also being associated with the specific user account; and
making the shipping cost estimate available to the transferee over the computer network, via the specific user account.

19. The method of claim 18, wherein the image data is received through a user interface provided to the transferee over the network.

20. A computer software system for providing a remote shipping cost estimate of a transferee's goods, the system having a set of instructions for controlling at least one computer device and being stored on computer-readable media, which when executed by the at least one computer device carries out a method comprising:
remotely receiving image data of a transferee's goods;
obtaining a shipping cost estimate of the transferee's goods that is based on the remotely received image data; and
making the shipping cost estimate available to the transferee.
